(19) United States
(12) Patent Application Publication
(10) Pub. No.: US 2012/0124554 A1
(43) Pub. Date: May 17, 2012

(54) SERVICE-ORIENTED APPLICATION SYSTEM AND COMMUNICATING METHOD, CREATOR AND CREATING METHOD THEREOF

(76) Inventor: Ka Fai Keith Tam, Hong Kong (CN)

(21) Appl. No.: 13/318,480

(22) PCT Filed: Apr. 30, 2010
(86) PCT No.: PCT/CN10/00599

§ 371 Date: Jan. 16, 2012

(30) Foreign Application Priority Data
May 4, 2009 (CN) 200910137109.9

(51) Int. Cl. G06F 9/44

(52) U.S. Cl. 717/121

(57) ABSTRACT

A service-oriented application system including one or more application objects, each application object includes: a plane structure data unit dedicated to storing data of a special type; a relation storage unit for storing the relations between data in said data unit and data in data units of other application objects; and an application code module for operating the data in the data unit and information in the relation storage unit, and for operating the plane structure data unit and the relation storage unit in response to network service requests. A communication method for the service-oriented application system, a creator and method for creating the service-oriented application system are also provided. The solution can quickly establish and modify the service-oriented application system with no information isolated island exists in the application system, and allows users to share their service data with their providers, customers and collaborators.

### TECHNICAL FIELD

The present invention relates to the technical field of network application, particularly to a service-oriented application system, the communication method of the service-oriented application system, the method used to create the service-oriented application system and the creator used to create the service-oriented application system.

### BACKGROUND

In the traditional application development, user needs are firstly surveyed, and then the database is designed based on user needs, followed by application programming and user interface design. Generally, because of cost-effectiveness considerations in the development of these applications, attempts are made to handle the similar needs in different business functions, such as enterprise resource planning, customer relationship management and human resource management. However, in practice, it is difficult for the packaged software applications to be developed in this way to achieve the expected results, mainly due to the following reasons:

Firstly, various business information is handled differently, thus it is difficult to achieve unified handling. For a variety of businesses, no matter whether the information comes from different technical fields or from the same technical field, the ways to handle such information are usually different, because there is a huge difference in business environment and business practices.

Second, the software applications are too complicated. The packaged software products developed in said way tries to summarize the common needs in different business functions. Then, the software applications are gradually upgraded over time, eventually leading to more and more functional components, which are actually not needed in most businesses.

Furthermore, there are data integration problems. The packaged software products developed for a variety of businesses is generally designed and developed based on different concepts and different functions, and such packaged software products often cannot communicate with each other. The users (such as companies or enterprises), who need the applications related to various businesses, often need to purchase various packaged software products; however, because such packaged software products cannot communicate with each other, multiple information isolated islands are formed for users possessed of more than one such packaged software product. When possessing such packaged software, a company usually has to invest a lot of manpower and material resources in maintaining the related information of such software, and it is difficult to guarantee the completeness and consistency among such information; moreover, a lot of redundancy exists.

In addition, such software cannot meet the changing needs of users in a cost-effective manner during its use. Business information is usually volatile, and has internal relevance; however, the packaged software designed based on a predefined and rigid data model cannot associate such changing information in a desired and appropriate manner in the course of its use. Therefore, based on prior art, it is difficult to meet user needs at a lesser cost.

### SUMMARY

In view of this, the present invention aims to at least partially solve said problems in the application development based on prior art and existing applications.

For this purpose, this invention provides a service-oriented application system, the communication method of the service-oriented application system, as well as the method and the creator used to create the service-oriented application system.

According to one aspect of the present invention, it provides a service-oriented application system. Said application system includes one or more application objects, and each application object includes: a plane structure data unit dedicated to storing data of a special type; a relation storage unit for storing the relations between the data in said data unit and the data in data units of other application objects; and an application code module for operating the data in the data unit and the information in the relation storage unit, wherein said application code module is used for operating the plane structure data unit and/or the relation storage unit, in response to network service requests.

According to one embodiment of the present invention, said application object includes a platform, and the platform is an application object, including a plane structure data unit dedicated to storing said configuration information, and wherein the application code module of the platform responds to the network service requests specific to said configuration information, and searches the corresponding configuration information, so as to return the configuration information.

According to another embodiment of the present invention, the relation storage unit of said platform is used to store the information in the relation storage units of other application objects.

According to a further embodiment of the present invention, said application object includes a data application object, which includes a plane structure data unit dedicated to storing business data.

According to still a further embodiment of the present invention, said data application object further includes a plane structure data unit dedicated to storing the common part of said configuration information related to said data application object.

According to yet another embodiment of the present invention, wherein said application further includes middleware, which is used to convert said configuration information into the information of common format which can be understood by various client application systems related to said service-oriented application system.

According to still another embodiment of the present invention, wherein said application further includes an adapter, which is used to convert the network service requests from a third-party system or the returned network service responses into the information of the format suitable for said service-oriented application system or suitable for the client application system related to said service-oriented application system; and/or convert the network service responses returned or the network service requests sent by said service-oriented application system or said client application system into the information of the format suitable for a third-party system.

According to a further embodiment of the present invention, wherein said application code module is used to carry out one or more of the following operations: add data into the plane structure data unit; delete data from the plane structure data unit; renew data in the plane structure data unit; search data in the plane structure data unit; add information into the relation storage unit; delete information from the relation storage unit; renew information in the relation storage unit; and search information in the relation storage unit.

According to another aspect of the present invention, a communication method of the service-oriented application system is provided, wherein said service-oriented application system includes one or more application objects, and each application object includes a plane structure data unit dedicated to storing data of a special type, a relation storage unit for storing the relations between the data in said data unit and the data in data units of other application objects, and an application code module for operating the data in the data unit and the information in the relation storage unit; said method includes: responding to network service requests, and operating the plane structure data unit and/or relation storage unit via the application code module.

According to yet another aspect of the present invention, a method used to create the service-oriented application system is provided, including: to select one or more application templates, wherein said application template includes user interface, application object and corresponding actions, and the application object includes: a plane structure data unit dedicated to storing data of a special type, a relation storage unit for storing the relations between the data in said data unit and the data in data units of other application objects, and an application code module for operating the data in the data unit and the information in the relation storage unit; to configure said application template according to user needs, so as to generate the configuration information specific to said users; and to package said application template and said configuration information to generate an application package suitable for user needs;

According to one embodiment of the present invention, said method further includes: to perform deployment for said application package, so as to provide said service-oriented application system.

According to another embodiment of the present invention, said method further includes: to save said application package for subsequent creation of other applications; and/or to export said application package for use by external application creation personnel.

According to yet another embodiment of the present invention, wherein to select one or more application templates includes one or more of the following operations: select user interface and/or application object and/or corresponding actions from the memory pool; select the predefined application package from the memory pool; and import the predefined application package, wherein said predefined application package includes multiple application templates used to achieve specific functions, or includes multiple application templates for achieving specific functions and the related configuration information.

According to still another embodiment of the present invention, wherein to configure said application template includes one or more of the following operations: delete said user interface, said application object or said actions at least; modify said user interface, said application object or said actions at least; add said user interface, said application object or said actions at least; set the protocol followed by network service requests.

According to a further embodiment of the present invention, wherein the generated application package includes: a data application object, which includes the plane structure data unit dedicated to storing business data; and/or a platform, which is an application object, including the plane structure data unit dedicated to storing said configuration information.

According to still a further embodiment of the present invention, wherein said configuration information includes the user interface information and/or network service request information.

According to another aspect of the present invention, a creator used to create the service-oriented application system is provided, including: a selection unit, which is used to select one or more application templates, wherein said application template includes an user interface, an application object and corresponding actions; the application object includes: a plane structure data unit dedicated to storing data of a special type, a relation storage unit for storing the relations between the data in said data unit and the data in data units of other application objects, and an application code module for operating the data in the data unit and the information in the relation storage unit; the configuration unit, which is used to configure said application template according to user needs, so as to generate the configuration information specific to said users; and packaging unit, which packages said application template and said configuration information to generate an application package suitable for user needs;

According to the present invention, the service-oriented application system comprises multiple application objects, preferably including the application object known as “platform” which is used to store the configuration information. Therefore, based on this structure, the predefined application template can be used to create the service-oriented application system in a fast and simple manner (by simple mouse operation, such as clicking, dragging & dropping).

Moreover, the selected predefined packaged file can be modified to satisfy the needs of specific users, or the application package originally created for other users can be slightly modified to create a similar application for another use. In addition, the existing service-oriented application system can be simply modified to adapt to customers' new needs.

According to the present invention, the business data of the same type (such as contact information) is stored in the same plane structure data unit of a logically single table or file; however, the plane structure data unit, the application object, and even the whole network application system can be located in multiple locations in the network, in other words, they can be located in multiple physical locations or multiple domains. According to the present invention, each plane structure data unit, each application object or the whole network application can be disposed in a single location or multiple locations according to business needs, or disposed in a single domain or multiple domains. For example, the small-sized companies can store them in a single location, and the large-sized international companies can provide them in multiple locations. Moreover, according to the present invention, the business data stored in a single logical table can be shared by multiple applications specific to different businesses, which is different from the traditional way in which packaged software products are developed for different businesses by making use of different concepts; according to the traditional way, packaged software products are designed for different businesses based on different concepts according to the predefined and rigid data model, and such packaged software products can neither communicate with each other, nor share business data. Therefore, in comparison with the traditional way, no information isolated island is formed for the business data in the network application system of the present invention. Thus, the problems regarding information integration and data integrity can be avoided, so as to relieve the users from data integrity maintenance work and other complicated work, reduce the costs and improve the efficiency.

Furthermore, according to the present invention, different client application systems (e.g. a user's client application system, the client application system of the user's client, the client application system of the user's associate) can correspond to a subset of different application objects in a service-oriented application system, for example, it can be achieved by loading different configuration information. Thus, a user can appropriately share its business data with its providers, clients and associates. Therefore, the present invention not only brings many benefits for the user's company, but also brings convenience for the user company's value chain.

According to a preferred embodiment of the present invention, by using an adapter, the client application system and/or the service-oriented application system in the network application system of the present invention can communicate with a third-party system, so that a user's existing business system can be used in combination with the network application system of the present invention, thereby saving the costs. Moreover, by using an adapter, the network application system of the present invention can adapt to any change, so that it can exchange data with a third-party system by taking advantage of industry standards, such as REST mode or SOAP protocol, thereby further avoiding information isolated islands.

### BRIEF DESCRIPTION OF THE DRAWINGS

References are made to the accompanying drawings illustrating the embodiments from which said and other features of the present invention are apparent. In the accompanying drawings of the present invention, the same number means the same or similar component. In the drawings:

FIG. 1 schematically shows the network application system according to one embodiment of the present invention;

FIGS. 2a-2d schematically show an illustration of the application object according to the present invention;

FIG. 3 schematically shows an illustration describing the relation storage unit according to the present invention;

FIG. 4 schematically shows the communication flowchart of the network application system according to one embodiment of the present invention;

FIG. 5 schematically shows the network application system according to another embodiment of the present invention;

FIG. 6 schematically shows the network application system according to yet another embodiment of the present invention;

FIG. 7 respectively shows the XML file returned by a third party and the file formats which can be recognized by the network application system of the present invention;

FIG. 8 shows the illustrative format of the protocol used by network service requests and responses of a third-party system and the client application system of the present invention respectively;

FIG. 9 schematically shows the network application system according to still another embodiment of the present invention;

FIG. 10 schematically shows the network application system according to a further embodiment of the present invention;

FIG. 11 schematically shows the flowchart of the method used to create the service-oriented application system according to one embodiment of the present invention;

FIG. 12 schematically shows the block diagram of the creator used to create the service-oriented application system according to one embodiment of the present invention;

FIG. 13 schematically shows the block diagram of the creator used to create the service-oriented application system according to another embodiment of the present invention;

FIG. 14 schematically shows the block diagram of the creator used to create the service-oriented application system according to yet another embodiment of the present invention;

FIG. 15 schematically shows the block diagram of the creator used to create the service-oriented application system according to still another embodiment of the present invention; and

FIG. 16 schematically shows the block diagram of the computing devices, which can be used to realize the embodiments of the present invention.

### DETAILED DESCRIPTION

The service-oriented application system, the communication method of the service-oriented application system, the method used to create the service-oriented application system and the creator used to create the service-oriented application system provided by the present invention are described through the embodiments by reference to the accompanying drawings.

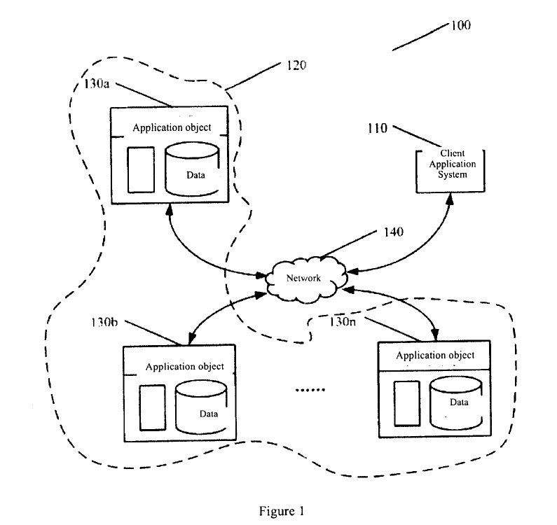

Firstly, to more clearly and conveniently describe the service-oriented application system and its communication method according to the present invention, references to FIGS. 1-10 are made to describe the network application system and its communication method according to the embodiments of the invention, so as to further describe the service-oriented application system and its communication method.

FIG. 1 schematically shows the network application system according to one embodiment of the present invention. As shown in FIG. 1, the network application system 100 includes the client application system 110 and the service-oriented application system 120, wherein the service-oriented application system 120 comprises the application objects 130a, 130b . . . 130n. The communication between the client application system 110 and the service-oriented application system 120 is made through the network 140.

The network 140 can be of any type or the combination of the networks composed of the devices, which can communicate with each other. For example, the network 140 can be a TCP/IP network, such as the global Internet generally known as “Internet”. The client application system 110 can be any network client application, which can control the content and layout directly or indirectly running on any operating system. The network client application 110 can be a rich internet application (RIA) run by using or not using a network browser, such as Flash application, Java application, JavaFX application, Adobe Flex/AIR application, Microsoft Silverlight application, wherein the RIA can run on a dedicated network browser plug-in, or run independently in a Sandbox guaranteeing safe operation of programs; or, it can be a script application running on a network browser, such as Javascript application, VBScript; or other applications developed with various programming languages (such as .NET, Java, C, C++, Ruby and Python) and directly running on the operating system. Moreover, the network client application can be any network-based application, and based on Windows operating system, Linux system, or any other appropriate operating system. The client application system 110 can even be linked to small applications of certain websites (e.g. company website, Blog and large commercial websites, like Alibaba and Eachnet) for convenient use. For example, a user can link its product catalogue and online inquiry & payment to the websites of its associates for convenient use

The client application system 110 is achieved to send a network service request to the service-oriented application system 120, for example, a request for the corresponding application object in the service-oriented application system 120 to add, delete, search and update data, and receive the network service response from the application object, for example, the returned search data.

The client application system 110 can be configured to start operation by loading configuration information. The configuration information decides how the client application system 110 interacts with the user and initiates a network service request. The configuration information is described in detail below.

The client application system 110 can run on any equipment or system, as long as the equipment or system can support the communication between the client application system and the service-oriented application system. The equipment or system can be personal computers, e.g. desktop computers; handheld computing devices, e.g. iPhone, Blackberry, the mobile phones with Windows Mobile system installed and smart phones; portable computing devices, e.g. notebooks, netbooks; and workstations, computing device network, etc.

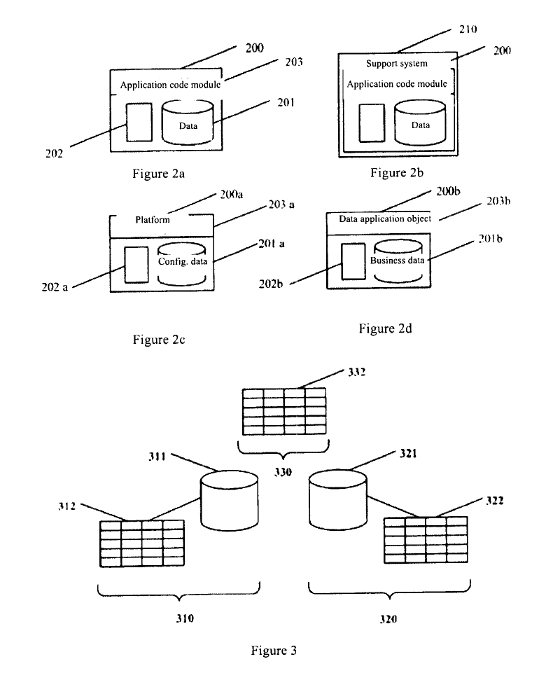

The service-oriented application system 120 includes one or more application objects, such as 130a, 130b . . . 130n. In the present invention, “application object” can also be called “building block” server application, and the solutions specific to different functional needs can be developed with different combinations of such “building block” server applications. Below, references to FIGS. 2a-2d are made to fully describe the application objects comprising the service-oriented application 120.

FIGS. 2a-2d schematically show an illustration of the application object according to the present invention. As shown in FIG. 2a, the application object 200 can include the plane structure data unit 201, relation storage unit 202 and application code module 203; wherein the plane structure data unit 201 can be dedicated to storing the data of a special type, such as contact information, order information, project information or application-related configuration information; the relation storage unit 202 can be used to store the relations between the data in the plane structure data unit 201 and the data in the data units of other application objects; whereas the application code module 203 can be used to operate the data in the plane structure data unit 201 and the information in the relation storage unit 202, for example, adding data to the plane structure data unit 201 and/or the relation storage unit 202.

As shown in FIG. 2b, the application object 200 can run on the support system 210, and the support system 210 refers to the combination of the following features: any platform allowing the application object 200 to run on it, e.g. the operating system; any database management system allowing the relation storage unit 202 and the plane structure data unit 201 to reside on it, e.g. RDBMS, Oracle, DB2, MySQL, MS SQL; an application framework allowing the application code modules developed by using various programming languages (e.g. JavaScript, VBScript, .NET, Java, PHP, C, C++, Ruby, Python) to run on it; and the equipment or systems allowing the operation of any platform, database management system and application framework.

The plane structure data unit 201 included in the application object 200 can be a simple XML document or a single logical table in a relation database, such as MySQL, MS SQL, Oracle and DB2 (although the plane structure data unit can be achieved in tables stored in different locations). According to the invention, the plane structure data unit 201 of each application object is dedicated to storing the data of a special type, that is, different types of data are stored in the plane structure data units of different application objects, and the types of the data stored in the plane structure data units of different application objects are different from each other. In addition, different from the traditional relation databases, the relations between the data stored in the plane structure data unit 201 and the data stored in the plane structure data unit of other application objects are not expressed by adding a foreign key into a table, for example, but by the relation storage unit 202 included in the application object 200, and the relation storage unit are described in detail below.

It is noted that each application object 200 can have the same structure, that is, each application object can include the plane structure data unit 201, the relation storage unit 202 and the application code module 203. However, each plane structure data unit 201 can have a different internal structure, for example, the plane structure data unit 201 in the form of a single logical table can have the fields of different types and quantity, so as to store different types of data, such as contact information, order information, project information and the configuration information of the client application system corresponding to the service-oriented application system.

As shown in FIG. 2c, the plane structure data unit 201a in the application object 200a is dedicated to storing the configuration information of the client application system, wherein the configuration information can be acquired by the client application system, so as to activate the client application system. Therefore, in this sense, the application object 200a can also be called “platform”. As shown in FIG. 2d, when the plane structure data unit 201b in the application object 200b is dedicated to storing common business data, it plays a role in providing business data service for the client application system, thus it can also be called “data application object”.

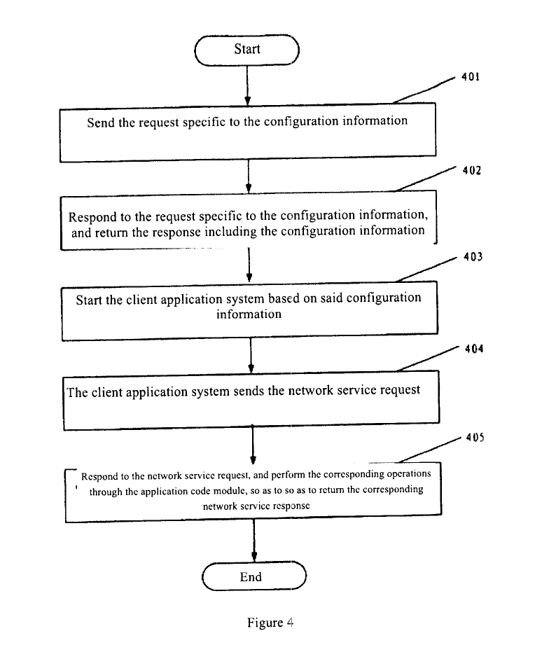

The relation storage unit 202 included in the application object 200 plays a role in expressing the relations between the data in the plane structure data unit of each application object. Below, references are made to FIG. 3 to give a more detailed description of the relation storage unit of the invention.

FIG. 3 shows an illustration describing the relation storage unit according to the present invention, wherein the relation storage unit is a linking table. FIG. 3 shows the plane structure data unit 311 and linking table 312 included in the data application object 310, the plane structure data unit 321 and linking table 322 included in the data application object 320, and the linking table 332 in the platform 330. It is noted that the application code modules in the data application objects 310 and 320, and the plane structure data unit and application code module in the platform are not shown for clarity.

The linking tables 312 and 322 as shown in the figure are used to store the linking relations between the plane structure data unit 311/322 and the plane structure data units of other application objects respectively. According to the embodiments of the invention, if the data in a plane structure data unit has linking relations with the data in the plane structure data unit of any other application object, the linking table corresponding to the two plane structure data units will have the linking records indicating the linking relations. In addition, preferably, the central linking table 332 of the platform 330 also has the linking records corresponding to it, and by making use of the linking records, record recovery can be carried out in case of loss of the linking records in the data application object.

For example, if the data record A in the plane structure data unit 311 is linked to the data record B in the plane structure data unit 321, the linking table 312 corresponding to the plane structure data unit 311 has such linking records, which include the identification (as the primary key) of the linked record A, the identification of the data application object 320 whose record B is linked, and the identification of the linked record B; the linking table 322 corresponding to the plane structure data unit 321 also has the corresponding linking records, which include the identification (as the primary key) of the linked record B, the identification of the data application object 310 whose record A is linked, and the identification of the linked record A; and preferably, the central linking table 332 of the platform 330 can also store the corresponding linking records, which include the identification of the data application object 310 whose record A is linked, the identification of the linked record A, the identification of the data application object 320 whose record B is linked, and the identification of the linked record B.

When it is needed to link the two records, the linking relation between the two records can be established by storing such two records in the two linking tables corresponding to the two plane structure data units respectively, and preferably, adding said linking records into the central linking table of the platform, so as to link the two records.

Thus, to view the linking items related to a certain record through the client application system, a user can search all the linking records whose primary key is the identification of the record in the linking table corresponding to the plane structure data unit storing the record. Then, based on the identification of the application object whose records are linked according to the searching result, the user can send a network service request to the application object, so as to get the linked records, and the identification possessed by the linked records is the identification of the linked records included in the searched linking records.

It is noted that the linking table is just an example of the relation storage unit used to store the relations between the data stored in each plane structure data unit. The invention is not limited by this, and any other appropriate technology can be adopted to store these linking records, such as XML file and other files, as long as such linking information can be maintained. Other relevant technical details on achieving the storage of linking records are known to those skilled in the art.

References to FIG. 2 are made to continuously describe the application object according to the invention.

In the FIG. 2, the application code module 203 is configured to respond to the network service requests (e.g. the requests of REST mode or SOAP protocol) from the client application system or other application objects, so as to operate the data in the plane structure data unit 201 and/or the information stored in the relation storage unit 201 of the linking table. Based on the appropriate technology (such as .NET, JAVA, PHP, C, C++, Ruby and Python), which achieves said support system 210, the application code module 203 can be developed. The application code module 203 can contain the basic methods for basic operation of the data, including but not limited to creation, searching, updating and deletion of the data in the plane structure data unit and the linking information in the linking tables. Moreover, these basic methods can be designed as the network service requests of any format supporting SOAP protocol and/or REST mode, so as to respond to the network service requests and operate the data in the plane structure data unit or the information in the relation storage unit. Under the circumstance that the service-oriented application system includes the platform, the application code module in the platform can be configured to respond to the network service requests specific to said configuration information and search the corresponding configuration information, so as to return the configuration information.

It is noted that with respect to the plane structure data units adopting different technologies, the realization of said basic methods is also different, for example, with respect to the plane structure data unit in the form of XML file, the basic methods include XML query language, such as Xquery; with respect to the plane structure data unit in the form of the table in the relation database, the basic methods can include structured query language (SQL), which is known to those skilled in the art.

Furthermore, it is noted that as far as all the application objects are concerned, all the application code modules can be completely identical, which helps to speed up the deployment process. However, this invention is not limited by it, and different application code modules can be configured specific to different application objects.

Moreover, it is noted that each application object (namely, platform or data application data) according to this invention can be located on one or more devices, and one or more application objects can also be located on one device.

In the above, the network application system according to one embodiment of the invention has been described, and below, references to FIG. 4 are made to describe the communication method of the network application system according to the invention.

Referring to FIG. 4, firstly, a request specific to the configuration information is sent in step 401, so as to start the client application system.

According the embodiments of the present invention, the client application system is configured to start by loading the configuration information. The configuration information includes the user interface information and/or network service request information. The user interface information decides how the client application system interacts with the user, that is, what interface should be presented to a user. The network service request information decides how to initiate a network service request, that is, what protocol shall be based on to initiate a request and what request shall be initiated. For different users, the configuration information can be different, and for different types of user equipment, their configuration information can also be different, but the invention is not limited by it. The request shall possess the format, which can be interpreted by the entity storing the configuration information, for example, the network service requests of any format supporting SOAP protocol and/or Rest format, or the requests of other formats.

Then, in step 402, the request specific to the configuration information is responded, and the response including the configuration information is returned.

In one embodiment of the present invention, the configuration information is stored in the plane structure data unit of the platform 130a in the service-oriented application system. The application code module in the platform 130a responds to the request, searches the requested configuration information and returns the searched configuration information.

Then, in step 403, the client application system is started based on said configuration information. According to the user interface information of the received configuration information, the client application system is started to display the corresponding user interface for interaction.

Next, in step 404, the client application system sends the network service request.

In the process of interaction through the user interface presented by the client application system, the network service request can be sent by triggering the component on the user interface. The network service request can be sent based on the network service request information in the configuration information, and the network service request corresponds to the component and has the format defined by the network service request information.

Afterwards, in step 405, the network service request is responded, and the corresponding operations are performed by the application code module, so as to return the corresponding network service response. The application code module is configured to understand the network service request, and perform basic operations (such as creation, deletion, query and renewal) for the plane structure data unit and/or the relation storage unit of the linking table according to the requested network service. Then, it can return the network service response corresponding to the network service request.

It is noted that as far as the invention is concerned, it is preferable to store configuration information in the platform, but the invention is not limited by it, and the configuration information can also be stored in other locations of the network, as long as the information can be acquired by the client application system, and the configuration information can even be stored in the user equipment where the client application system is located. Moreover, according to the invention, operation can be performed for one data application object in one network request, for example, adding data into it. However, multiple operations can be performed for several data application objects, for example, establishing linking relations while adding data.

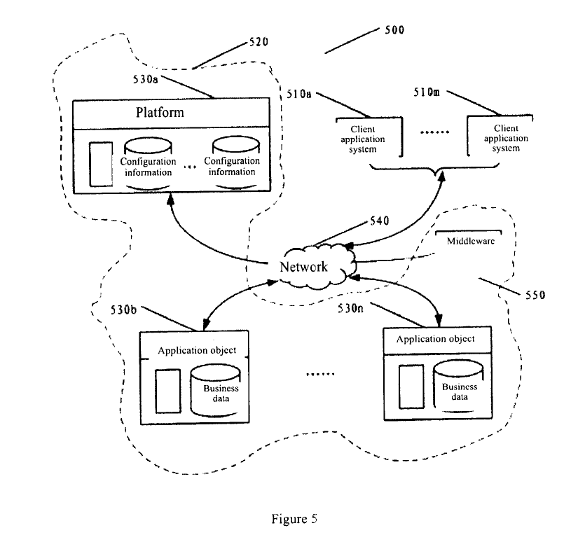

References to FIG. 5 are made to describe the network application system according to another embodiment of the present invention.

FIG. 5 shows the network application system 500 according to another embodiment of the present invention. The network application system shown in FIG. 5 includes different client application systems 510a . . . 510m which run on different hardware, such as desktops, laptops and handheld devices. In the platform 530a of the service-oriented application system 520, the configuration information corresponding to different client application systems 510a . . . 510m is stored. Before the client application system 510 is started, the client application system will send the network service request specific to the configuration information to the platform 530a, and the platform 530a will respond to the network service request and return the corresponding configuration information to the client end.

However, due to the limitations of hardware, in general, a simplified version of client-end system has to be installed on the user's equipment, such as handheld devices, but some problems may occur, for example, the configuration information from the platform 530a cannot be interpreted. For this purpose, the service-oriented application system 520 also includes the middleware 550, which allows the client application systems 510a . . . 510m running on different hardware to access the service-oriented application system 520 of the invention. The middleware 550 is similar to the application object, which can run on said support system 210, and similar to the application object, the middleware 550 can also be developed by the appropriate technologies which are used to achieve said support system 210, such as .Net, JAVA, PHP, C, C++, Ruby and Python.

When the client application system cannot interpret the configuration information, assistance from the middleware 550 can be requested, and the middleware can convert said configuration information into the information of the format which can be understood by the client application system, for example, when the client application system uses a browser to run, conversion into the common HTML label can be achieved. In another embodiment of the present invention, when the client application system cannot interpret the configuration information, it can send a network service request for format conversion to the platform 530a, or implementation of format conversion is required in the network request specific to configuration information sent by the client application system. The platform 530a will send the configuration information to the middleware 550 for format conversion. Then, the middleware 550 will send the converted configuration information to the corresponding client application system, or the platform notifies the corresponding client application system to acquire the configuration information from the middleware 550. In yet another embodiment of the invention, the client application system can request configuration information from the middleware 550 directly; the middleware 550 communicates with the platform 530a based on the configuration request, and acquire corresponding configuration information from it; then, the middleware 550 performs data format conversion for the acquired configuration information, and send the converted configuration information to the client application system.

In said embodiment, the middleware 550 is a separate component, however, it is noted that the middleware 550 can also integrate with the platform 530a. In this way, the client application system requests configuration information from the platform 530a directly; if conversion is required, the middleware included in the platform 530a can perform format conversion; if conversion is not required, the middleware can be bypassed, and the configuration information is directly sent to the client application system through the network 540.

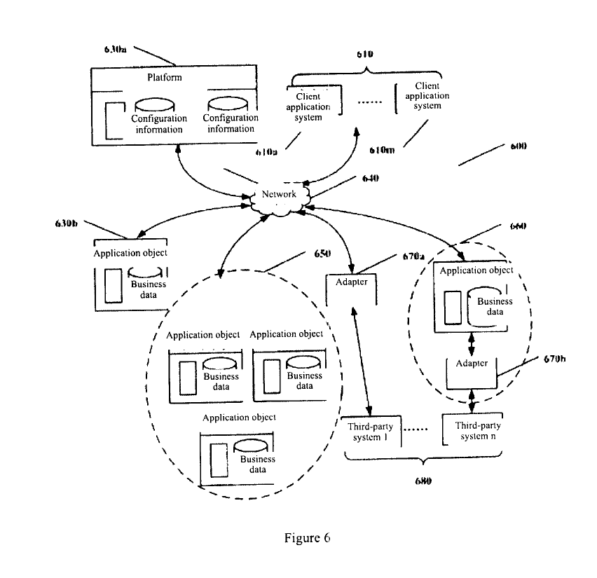

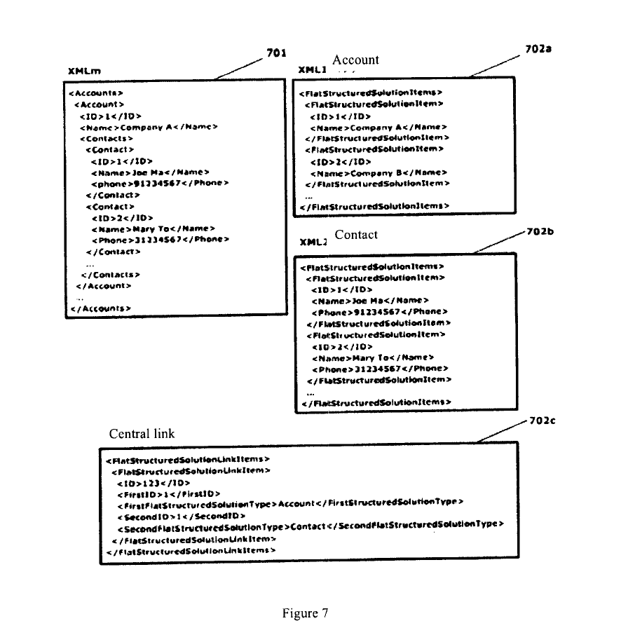

In addition, FIG. 6 also shows the network application system 600 according to yet another embodiment of the present invention. In the network application system 600 shown in FIG. 6, in addition to the client application system and the corresponding service-oriented application system, a third-party system 680 also exists. For example, the third-party system can be the system of other parties (e.g. the company's clients, suppliers, associates) which constitute a consortium with the user of the client application system, or the system of other departments of the company. A third-party system is generally an application system different from the system of the invention; therefore, its network service requests are possibly different from that adopted by the service-oriented application system of the invention based on the plane structure data unit. In general, a third-party system's network service requests and the responses that it can interpret have the a structural hierarchy; however, the invention is based on a plane structure data unit, so the network service requests of the invention and the returned network service responses have no structural hierarchy. As shown in FIG. 7, for example, XMLm 701 can be a response returned by a third party, and the data information in the file has hierarchical relations, whereas the corresponding XML1 702a, XML2 702b and the central link 702c are the files without structural hierarchy, that is, plane XML files, and the relations (architecture) between XML1 702a and XML2 702b are expressed through the central link 702c . Therefore, in general, the two formats of information cannot understand each other. Moreover, when a third-party system communicates with the client application system, even thought their network service requests and responses are based on the plane structure data unit of the invention, the protocols used by them may be different. FIG. 8 illustratively shows the circumstance, for example, the network service request used by the client application system is the request of REST mode shown in 801, whereas the network service request used by a third-party system is the request of SOAP protocol shown in 802. Therefore, this circumstance may result in communication barriers between a third-party system and the network application system of the invention.

Therefore, to enable a third party to access the service-oriented application system, this invention provides a network service adapter, which can convert the network service requests from a third-party system or the returned network service responses into the information of the format suitable for said service-oriented application system or suitable for the client application system corresponding to said service-oriented application system; and/or convert the network service responses returned or the network service requests sent by said service-oriented application system or said client application system into the information of the format suitable for a third-party system. For example, it can convert the requests of REST mode into the requests of SOAP protocol which can be understood, and integrate the non-hierarchical XML files returned by the system of the invention into the hierarchical XML files which can be understood by a third-party system, and vice versa.

In this way, a third party can communicate with the client application system and/or data application object. Under the circumstance that the user has been possessed of some business systems, these existing business systems can be integrated with the network application system of the invention through the network service adapter, so as to save resources for the user's company and avoid the waste resulting from repeated investment.

It is noted that the adapter can be a separate component as shown in adapter 670a, or be packaged into any service-oriented application system as shown in adapter 670b. Similar to the application object and middleware, the adapter 670a and 670b can run on said support system 210, and the adapter can also be developed based on the appropriate technologies which are used to achieve said support system 210, such as .Net, JAVA, PHP, C, C++, Ruby and Python.

For the details about the network service adapter, please refer to the U.S. patent application Ser. No. 13/318,479 titled “Adapting method, adapter and adapter system for network service communication,” disclosure of which is herein incorporated by reference in its entirety.

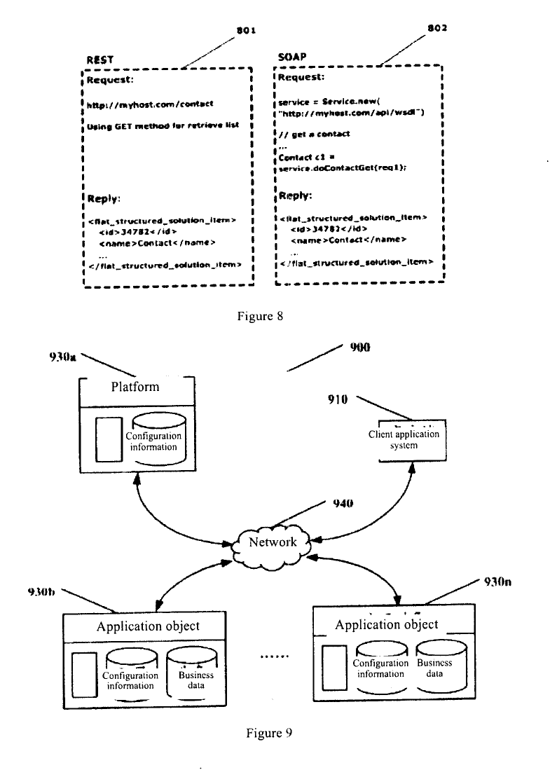

Furthermore, FIG. 9 shows the network application system according to still another embodiment of the present invention. According to the embodiment shown in FIG. 9, not all configuration information is centrally stored in the data unit of the platform 930a, but only the configuration information specific to the client application system is stored in the platform 930a; with respect to the common configuration information possessed by all the client application systems, a plane structure data unit dedicated to storing the common configuration information can be established in the corresponding data application object 930b . . . 930n, so as to store the relevant configuration information, as shown in FIG. 9.

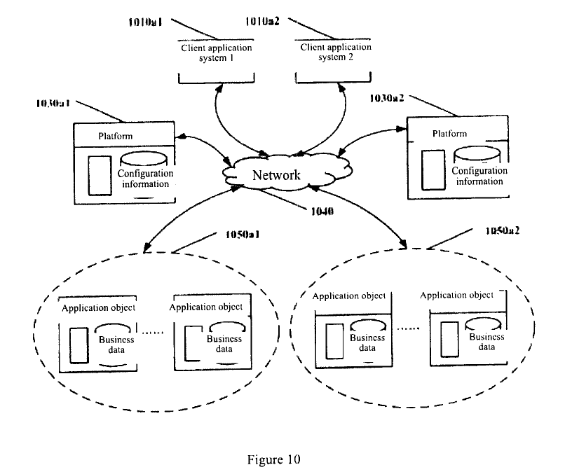

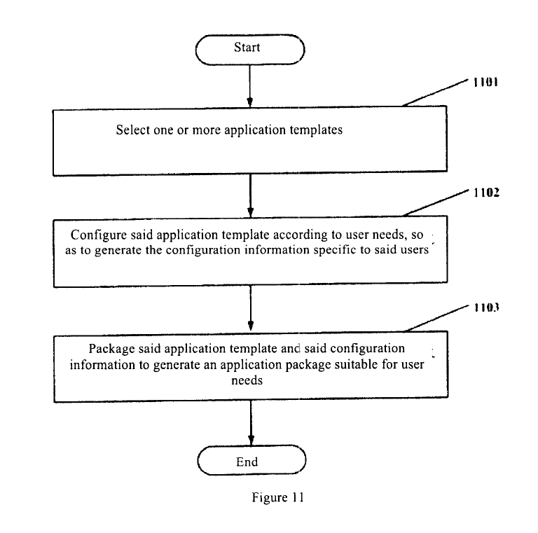

Moreover, FIG. 10 shows the network application system according to a further embodiment of the present invention. In the network application system shown in FIG. 10, there are the first client application system 1010a1, the first platform 1030a1 used to store the configuration information related to the first client application system 1010a1 and the first service-oriented application system 1050a1 corresponding to the first client application system 1010a1; and the second client application system 1010a2, the second platform 1030a2 used to store the configuration information related to the second client application system 1010a2 and the second service-oriented application system 1050a2 corresponding to the second client application system 1010a2. The first client application system and the second client application system can be the parties belonging to a consortium, for example, a company and its clients, suppliers, associates, etc. In the network application system according to the invention, the first client application system 1010a1 can send the network service request to the application object in the service-oriented application system 1050a2 through the network 1040, and the application object in the service-oriented application system 1050a2 can respond to the network service request, and provide the corresponding network service response to the first client application system 1010a1, and similarly, the second client application system 1010a2 can access the application object in the first service-oriented application system 1050a1 through the network 1040. Therefore, in this network application system, data sharing and exchange can be achieved.

In the above, reference to FIGS. 1-10 has been made to illustratively describe the network application system of the invention and several embodiments of its communication method. However, it is noted that when the client application system and the service-oriented application system run on the same equipment, there can be no the networks 140, 540, 640, 940 and 1040 actually.

Furthermore, it is noted that although only one client application system is shown in some embodiments, actually, there can exist several client application systems corresponding to the same service-oriented application system. The network application system can also include multiple different service-oriented application systems corresponding to multiple client application systems respectively, and include multiple platforms corresponding to multiple client ends respectively.

In addition, it is noted that the client application system and the service-oriented application system can also run on one or more devices in the network; under the circumstance that the networks 140, 540, 640, 940 and 1040 belong to the Internet, the client application system and the service-oriented application system can also run in one or more domains. Besides, it is noted that all the client application systems residing on the user's equipment (or system) can be common applications developed based on the technologies supporting such systems; by loading different configuration information, these client application systems can satisfy different user needs. However, this invention is not limited by it, and all the client application systems can also share the same configuration information.

In the above, by illustrating the network application system and its communication method of the invention, the service-oriented application system and the client application system and their communication methods of the invention are described. However, it is noted that each service-oriented application system and each client application system of the invention can be provided by one or more software providers, as long as the same communication protocol is followed between the service-oriented application system and the client application system. Therefore, this invention separately protects the service-oriented application system and the client application system based on this invention.

In the following, references to FIG. 11 are made to describe the method and the creator used to create the service-oriented application system according to the invention.

FIG. 11 shows the flowchart of the method used to create the service-oriented application system according to one embodiment of the present invention.

According to the embodiments of the present invention, one or more application templates are provided to speed up the application development process. The application template includes the user interface, application object and corresponding actions. The user interface is the interface presented to users in the form of webpage through a browser, so as to facilitate interaction with the user, and there are various components on the user interface, which can be provided to the user. The actions refer to the associated operations of the various components (buttons, selection boxes, textboxes, etc.) on the user interface, which are performed in response to the activation of the components on the user interface, e.g. displaying the corresponding pages, and sending the network service requests for data operation.

As described above, an application object includes: a plane structure data unit dedicated to storing data of a special type; a relation storage unit for storing the relations between the data in said data unit and the data in data units of other application objects; and an application code module for operating the data in the data unit and the information in the relation storage unit.

An application object is an object specific to a network service request. When an application object is used to store the application configuration information, it can also be called platform; when it is used to store common data information, it can be called data application object.

According to one embodiment of the present invention, a memory pool is provided, and the memory pool is used to store application templates. Therefore, the user interface and/or application object and/or corresponding actions can be selected from the memory pool.

According to another embodiment of the present invention, the application template is in the form of application package, and the application package includes multiple application templates used to achieve specific functions. Preferably, the application package further includes the related configuration information. In this case, to create a service-oriented application system which can achieve similar functions that the application package can achieve, the application package can be selected from the memory pool, so as to further accelerate the creation process of the service-oriented application system.

According to yet another embodiment of the present invention, the application package can be imported through the import component, so as to accelerate the creation process of the service-oriented application system.

Next, in the step 1102, said application template is configured according to user needs, so as to generate the configuration information specific to said user.

As far as different users are concerned, the required service-oriented application systems may be different; therefore, it may be necessary to configure the selected application template, that is, to adjust the application template to meet the user needs.

The user interface, application object and corresponding actions included in the selected application template can be modified, such as adding a component and its corresponding actions on the user interface; adding an application object; modifying the linking relations between the application objects; modifying the internal structure of a plane structure data unit (adding or deleting a field). In addition, the icons and pictures shown on the user interface can also be modified, so as to create personalized applications.

For example, if an application package is selected, the unnecessary user interface, application object and the related actions can be deleted from the application package; furthermore, user interface, application object and the related actions can also be added into the application package, so as to satisfy the various specific needs of the users.

In addition, the relevant protocol used by the network service requests can be specified, such as REST mode or SOAP protocol, and FIG. 8 illustratively shows the requests and responses based on the two protocols. After the application template is configured, the relevant configuration information can be acquired, and the configuration information includes the information related to the interface to be presented to the user, namely, the user interface information, and the network service request information. The user interface information decides how the client application system interacts with the user, that is, what interface should be presented to a user. The network service request information decides how to initiate a network service request, that is, what protocol shall be based on to initiate a request and what request shall be initiated. Based on said configuration, specific services can be provided to the users.

According to one embodiment of the present invention, the generated configuration information can be stored in one application object, then the application object can be called “platform”, accordingly, other application objects used to store business data can be called “data application objects”. However, this invention is not limited by it, and the configuration information can be stored in any appropriate location, which can be acquired by the client application system, and the configuration information can also be stored in any industry standard means.

Particularly, it is noted that according to the application development method based on the prior art, the packaged software designed by a predefined and rigid data model cannot associate the necessary information in a simple and economic manner after it is put into use. However, this invention can achieve the function easily. For example, a new link button can be added on the original user interface, and then the two application objects corresponding to the two piece of information requiring linkage can be associated by simple operations, such as clicking and dragging & dropping, so that the actions associated to the button can be created. Then, the configuration information can be updated. Afterwards, the “link” operation button can be displayed on the user interface when the user starts the client application system by loading new configuration information, so that the user can link the required information without the need to change the two application objects. Similarly, other modifications to the network application can be made conveniently according to the user needs, for example, unlinking the application objects.

Next, in the step 1103, said application template and said configuration information are packaged to generate the application package suitable for user needs.

In one embodiment of the present invention, the application package is further deployed, so as to provide the application package to the user.

In another embodiment of the present invention, to accelerate the creation process of the service-oriented application system, the generated application package can be further stored in the memory pool, so as to use for program development in the future.

In yet another embodiment of the present invention, to facilitate the sharing of the application package, the generated application package can be further stored in the memory pool for use by external application creation personnel. However, it is noted that the step of deployment execution is not a necessity. For example, the application creation personnel can create some self-defined application packages according to the original application templates in the memory pool, and then store them in the memory pool for future use. In this case, the step of deployment is not required.

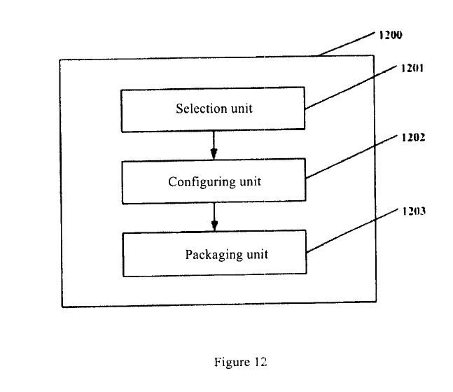

References to FIGS. 12-15 are made to describe the creator used to create the service-oriented application system according to the present invention.

FIG. 12 shows the creator used to create the service-oriented application system according to one embodiment of the present invention. As shown in the figure, the creator 1200 according to this invention includes: selection unit 1201, configuring unit 1202 and packaging unit 1203.

The selection unit 1201 is used to select one or more application templates. Said application template includes user interface, application object and corresponding actions. The application object includes: a plane structure data unit dedicated to storing data of a special type; a relation storage unit for storing the relations between the data in said data unit and the data in data units of other application objects; and an application code module for operating the data in the data unit and the information in the relation storage unit. The configuring unit 1202 is used to configure said application template according to user needs, so as to generate the configuration information specific to said users. The packaging unit 1203 is used to package said application template and said configuration information to generate an application package suitable for user needs.

In one embodiment according to this invention, said selection unit 1201 is further used for one or more of the following operations: select user interface and/or application object and/or corresponding actions from the memory pool; select the predefined application package from the memory pool; and import the predefined application package from outside, wherein said predefined application package includes multiple application templates used to achieve specific functions, or includes multiple application templates for achieving specific functions and the related configuration information.

In another embodiment according to this invention, said configuring unit 1202 is further used for one or more of the following operations: delete said user interface, said application object or said actions at least; modify said user interface, said application object or said actions at least; add said user interface, said application object or said actions at least; set the protocol followed by network service requests.

In yet another embodiment according to this invention, the generated application package includes: a data application object, which includes the plane structure data unit dedicated to storing business data; and/or a platform, which is an application object, including the plane structure data unit dedicated to storing said configuration information.

In still another embodiment according to this invention, said configuration information includes the user interface information and/or network service request information.

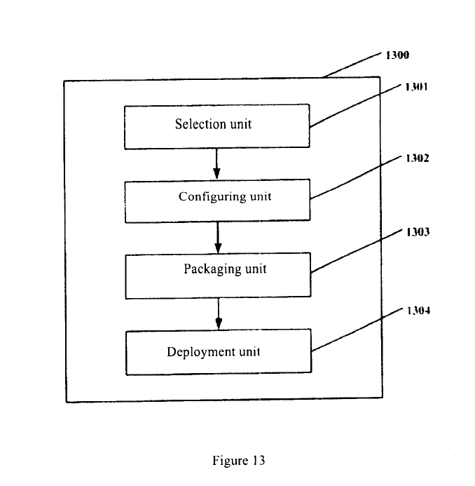

In addition, FIGS. 13, 14 and 15 also show other embodiments according to the present invention.

As shown in the figures, the creators 1300, 1400 and 1500 in FIGS. 13, 14 and 15 respectively include: the selection units 1301, 1401 and 1501, which correspond to the selection unit in FIG. 12 and are used to select one or more application templates; the configuring units 1302, 1402 and 1502, which correspond to the configuring unit 1202 in FIG. 12 and are used to configure said application template according to user needs, so as to generate the configuration information specific to said users; and the packaging units 1303, 1403 and 1503, which correspond to the packaging unit 1203 in FIG. 12 and are used to package said application template and said configuration information to generate an application package suitable for user needs.

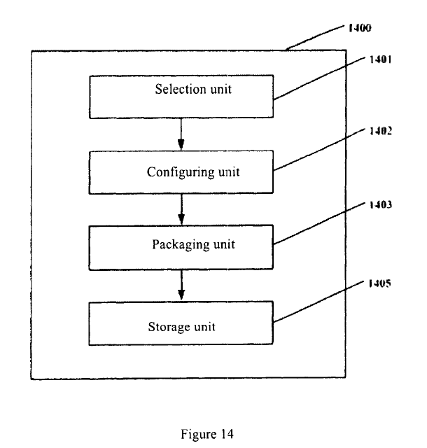

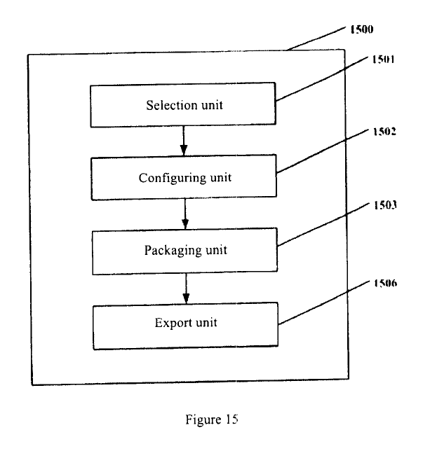

Different from the creator 1200 shown in FIG. 12, the creator 1300 shown in FIG. 13 further includes the deployment unit 1304, which is used to execute deployment for said application package, so as to provide said service-oriented application system for the user; the creator 1400 shown in FIG. 14 further includes the storage unit 1405, which is used to store said application package for subsequent creation of other applications; the creator 1500 shown in FIG. 15 further includes the export unit 1506, which is used to export said application package for use by the external application creation personnel.

It is noted that the various features shown above can be combined, as long as such combinations do not depart from the principles of the invention. For example, in another embodiment according to the present invention, the deployment unit 1304, import unit 1405 and export 1505 in said FIGS. 13, 14 and 15 respectively can be included.

According to the present invention, the service-oriented application system comprises multiple application objects, preferably including the application object known as “platform” which is used to store the configuration information. Therefore, based on this structure, the predefined application template can be used to create the service-oriented application system in a fast and simple manner (by simple mouse operation, such as clicking, dragging & dropping). Moreover, the selected predefined packaged file can be modified to satisfy the needs of specific users, or the application package originally created for other users can be slightly modified to create a similar application for another use. In addition, the existing service-oriented application system can be simply modified to adapt to customers' new needs.

According to the present invention, the business data of the same type (such as contact information) is stored in the same plane structure data unit of a logically single table or file; however, the plane structure data unit, the application object, and even the whole network application system can be located in multiple locations in the network, in other words, they can be located in multiple physical locations or multiple domains. According to the present invention, each plane structure data unit, each application object or the whole network application can be disposed in a single location or multiple locations according to business needs, or disposed in a single domain or multiple domains. For example, the small-sized companies can store them in a single location, and the large-sized international companies can provide them in multiple locations. Moreover, according to the present invention, the business data stored in a single logical table can be shared by multiple applications specific to different businesses, which is different from the traditional way in which packaged software products are developed for different businesses by making use of different concepts; according to the traditional way, packaged software products are designed for different businesses based on different concepts according to the predefined and rigid data model, and such packaged software products can neither communicate with each other, nor share business data. Therefore, in comparison with the traditional way, no information isolated island is formed for the business data in the network application system of the present invention. Thus, the problems regarding information integration and data integrity can be avoided, so as to relieve the users from data integrity maintenance work and other complicated work, reduce the costs and improve the efficiency.

Furthermore, according to the present invention, different client application systems (e.g. a user's client application system, the client application system of the user's client, the client application system of the user's associate) can correspond to a subset of different application objects in a service-oriented application system, for example, it can be achieved by loading different configuration information. Thus, a user can appropriately share its business data with its providers, clients and associates. Therefore, the present invention not only brings many benefits for the user's company, but also brings convenience for the user company's value chain.

According to a preferred embodiment of the present invention, by using an adapter, the client application system and/or the service-oriented application system in the network application system of the present invention can communicate with a third-party system, so that a user's existing business system can be used in combination with the network application system of the present invention, thereby saving the costs. Moreover, by using an adapter, the network application system of the present invention can adapt to any change, so that it can exchange data with a third-party system by taking advantage of industry standards, such as REST mode or SOAP protocol, thereby further avoiding information isolated islands.

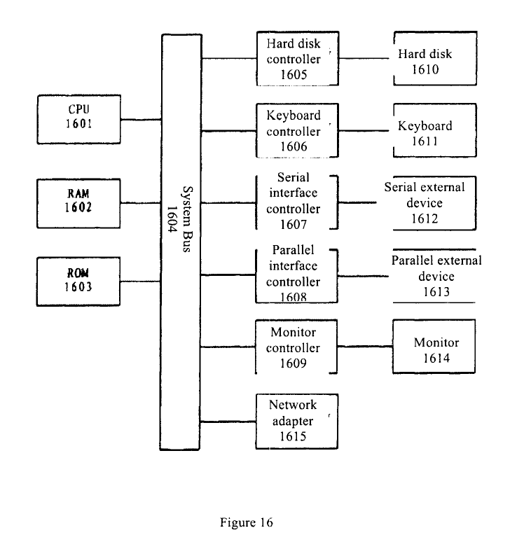

References to FIG. 16 are made to describe the computing devices, which can be used to realize the invention. FIG. 16 schematically shows the block diagram of the computing devices, which can be used to realize the embodiments of the present invention.

The computer system shown in FIG. 16 includes the central processing unit (CPU) 1601, random access memory (RAM) 1602, read-only memory (ROM) 1603, system bus 1604, hard disk controller 1605, keyboard controller 1606, serial interface controller 1607, parallel interface controller 1608, monitor controller 1609, hard disk 1610, keyboard 1611, serial external device 1612, parallel external device 1613, monitor 1614 and network adapter 1615. Among these components, CPU 1601, RAM 1602, ROM 1603, hard disk controller 1605, keyboard controller 1606, serial interface controller 1607, parallel interface controller 1608, monitor controller 1609 and network adapter 1615 are connected with the system bus 1604. The hard disk 1610 is connected with the hard disk controller 1605, the keyboard 1611 is connected with the keyboard controller 1606, the serial external device 1612 is connected with the serial interface controller 1607, the parallel external device 1613 is connected with the parallel interface controller 1608, the monitor 1614 is connected with the monitor controller 1609, and the network adapter 1615 allows the computer system to access the computer networks, such as the Internet.

The block diagram shown in FIG. 16 is intended to illustrate and not to limit this invention. In some circumstances, some devices may be added or reduced according to actual needs. For example, the computer used to achieve the invention can have no input/out devices, such as monitor and keyboard.

In addition, the embodiments of the present invention can be achieved by software, hardware or the combination of software and hardware. The hardware can be achieved by making use of the special logic; the software can be stored in the memory and its systems can be executed by appropriate instructions, for example, executed by microprocessor or dedicated design hardware.

Reference to the foregoing embodiments has been made to describe the invention, but it shall be understood that the invention is not limited by the disclosed embodiments. On the contrary, the invention aims to cover various changes and equivalent arrangements without departing from the spirit and scope of the appended claims. The scope of the claims below embodies the most extensive interpretation, so as to include all such changes and equivalent structures and functions.

What is claimed is:

1. A service-oriented application system, comprising one or more application objects, each application object comprising:
a plane structure data unit dedicated to storing data of a special type;
a relation storage unit for storing relations between data in said data unit and data in data units of other application objects; and
an application code module for operating the data in the data unit and information in the relation storage unit;
wherein said application code module is used for operating the plane structure data unit and the relation storage unit in response to network service requests.

2. The application system of claim 1, wherein said one or more application objects include at least a platform, the platform comprising:
a plane structure data unit dedicated to storing configuration information;
wherein application code module of the platform responds to the network service requests specific to said configuration information, and searches the corresponding configuration information, so as to return the configuration information; and
wherein relation storage unit of said platform is used to store information in relation storage units of other application objects.

3. The application system of claim 1, wherein said one or more application objects include at least a data application object, the data application object comprising a plane structure data unit dedicated to storing business data.

4. The application system of claim 3, wherein said data application object further comprising a plane structure data unit dedicated to storing common parts of configuration information related to said data application object.

5. The application system of claim 1, further comprising a middleware for converting configuration information into the information of common format, which can be understood by various client application systems related to said service-oriented application system.

6. The application system of claim 1, further comprising an adapter for converting network service requests from a third-party system or returned network service responses into information of format suitable for said service-oriented application system and suitable for client application systems related to said service-oriented application system, and for converting network service responses returned or network service requests sent by said service-oriented application system or client application systems into information of format suitable for a third-party system.

7. The application system of claim 1, wherein said application code module is used to carry out one or more of the following operations:
add data into the plane structure data unit;
delete data from the plane structure data unit;
renew data in the plane structure data unit;
search data in the plane structure data unit;
add information into the relation storage unit;
delete information from the relation storage unit;
renew information in the relation storage unit; and
search information in the relation storage unit.

8. A communication method of a service-oriented application system, said service-oriented application system comprising one or more application objects, each application object comprising:
a plane structure data unit dedicated to storing data of a special type;
a relation storage unit for storing relations between data in said data unit and data in data units of other application objects; and
an application code module for operating the data in the data unit and information in the relation storage unit;
said method comprising:
responding to network service requests, and
operating the plane structure data unit and the relation storage unit via the application code module.

9. The method of claim 8, wherein said one or more application objects include at least a platform, the platform comprising:
a plane structure data unit dedicated to storing configuration information;
wherein application code module of the platform responds to the network service requests specific to said configuration information, and searches the corresponding configuration information, so as to return the configuration information; and
wherein relation storage unit of said platform is used to store information in relation storage units of other application objects.

10. The method of claim 8, wherein said one or more application objects include at least a data application object, the data application object comprising a plane structure data unit dedicated to storing business data.

11. The method of claim 10, wherein said data application object further includes a plane structure data unit dedicated to storing the common part of said configuration information related to said data application object.

12. The method of claim 8, further comprising converting configuration information into information of common format which can be understood by client application systems related to said service-oriented application system.

13. The method of claim 8, further comprising:
converting network service requests from a third-party system or returned network service responses into information of format suitable for said service-oriented application system and suitable for client application systems related to said service-oriented application system; and
converting network service responses returned or network service requests sent by said service-oriented application system and client application systems into information of format suitable for a third-party system.

14. The method of claim 8, wherein operating the plane structure data unit and the relation storage unit still includes one or more of the following operations:
add data into the plane structure data unit;
delete data from the plane structure data unit;
renew data in the plane structure data unit;
search data in the plane structure data unit;
add information into the relation storage unit;
delete information from the relation storage unit;
renew information in the relation storage unit; and
search information in the relation storage unit.

15. A method for creating a service-oriented application system, comprising:
selecting one or more application templates, wherein said one or more application templates includes a user interface, an application object, and corresponding actions, wherein the application object includes:
a plane structure data unit dedicated to storing data of a special type;
a relation storage unit for storing the relations between data in said data unit and data in data units of other application objects; and
an application code module for operating data in the data unit and information in the relation storage unit;
configuring said one or more application templates according to user needs, so as to generate configuration information specific to said user; and
packaging said one or more application templates and configuration information to generate an application package suitable for meeting user needs.

16. The method of claim 15, further comprising deploying said application package, so as to enable said service-oriented application system.

17. The method of claim 15, further comprising:
saving said application package for subsequent creation of other applications; and
exporting said application package for use by external application creation personnel.

18. The method of claim 15, wherein selecting one or more application templates includes one or more of the following operations:
select an user interface and an application object and corresponding actions from the memory pool;
select a predefined application package from the memory pool; and
import the predefined application package;
wherein said predefined application package includes multiple application templates used to achieve specific functions.

19. The method of claim 15, wherein to configure said application template includes one or more of the following operations:
delete at least one of said user interface, said application object, and said actions;
modify at least one of said user interface, said application object, and said actions;
add at least one of said user interface, said application object, and said actions; and
set protocol followed by network service requests.

20. The method of claim 15, wherein the generated application package includes:
a data application object, which includes the plane structure data unit dedicated to storing business data; and
a platform, which is an application object and includes the plane structure data unit dedicated to storing said configuration information.
